(19) United States
(12) Patent Application Publication
(10) Pub. No.: US 2026/0113379 A1
(43) Pub. Date: Apr. 23, 2026

(54) MESSAGE DISPLAY METHOD, MESSAGE PROCESSING METHOD AND COMPUTING DEVICE

(71) Applicant: Hangzhou Alibaba International Internet Industry Co., Ltd., Hangzhou (CN)

(72) Inventors: Sze Wan FUNG, ShenZhen (CN); Wenhao HUANG, ShenZhen (CN)

(21) Appl. No.: 19/340,815

(22) Filed: Sep. 25, 2025

Related U.S. Application Data
(63) Continuation of application No. PCT/CN2024/087078, filed on Apr. 10, 2024.

(30) Foreign Application Priority Data
Apr. 10, 2023 (CN) 202310381991.1

(51) Int. Cl. H04L 67/141; H04L 51/10

(52) U.S. Cl. CPC H04L 67/141; H04L 51/10

(57) ABSTRACT

Embodiments of the present application provide a message display method, a message processing method, and a computing device. The message display method comprises: displaying a message display interface for a first session object associated with a target session connection, wherein the target session connection corresponds to a plurality of session objects; and based on at least two organizations to which the plurality of session objects belong, displaying, on the message display interface, session messages belonging to different organizations according to a first display style corresponding to each respective organization, wherein the first display styles corresponding to the different organizations are distinct. The technical solution provided by embodiments of the present application improves communication efficiency and reduces the impact on device performance.

### CROSS-REFERENCE TO RELATED APPLICATION

This application is a Continuation Application of International Patent Application No. PCT/CN2024/087078, filed on Apr. 10, 2024, which is based on and claims priority to and benefits of Chinese Patent Application No. 202310381991.1, filed with the China National Intellectual Property Administration on Apr. 10, 2023, and entitled “Message Display Method, Message Processing Method, and Computing Device.” The entire content of the above referenced applications is incorporated herein by reference.

### TECHNICAL FIELD

Embodiments of the present application relate to the field of communication technologies, and more particularly, to a message display method, message processing method, and computing device.

### BACKGROUND

In practical applications, there are scenarios where organizations communicate with each other. Since an organization often involves many personnel, in such communication scenarios, personnel within one organization often alternately perform communication work to communicate with another organization. The communication between the two organizations does not require identifying feedback from a specific member but can be feedback in the name of the organization.

The development of network and communication technologies provides convenient conditions for communication between organizations. Taking two organizations as an example, a plurality of personnel involved in the two organizations can establish a session connection through communication tools and achieve communication through session messages. However, in such session connections involving a plurality of personnel, because personnel communicate alternately, session messages are relatively scattered, making it difficult to distinguish session messages from different organizations, increasing the comprehension cost, thereby reducing communication efficiency, and also increasing the interaction time and the number of interactions with the device, thereby affecting device performance.

### SUMMARY

The embodiments of the present application provide a message display method, a message processing method and a computing device to solve the technical problems of low communication efficiency and affecting device performance in the prior art.

In a first aspect, the embodiments of the present application provide a message display method, including:
displaying a message display interface for a first session object associated with a target session connection; wherein the target session connection corresponds to a plurality of session objects;
based on at least two organizations to which the plurality of session objects belong, displaying, on the message display interface, session messages belonging to different organizations according to a first display style corresponding to each respective organization; wherein the first display styles corresponding to the different organizations are distinct.

Optionally, the method further includes:
when a session message associated with a first organization, to which the first session object belongs, is displayed using the first display style corresponding to the first organization, displaying a first session message of the first session object and a second session message, different from the first session message but also associated with the first organization, according to distinct second display styles.

Optionally, the method further includes:
for a session message associated with a first organization to which the first session object belongs, displaying session identification information generated based on a respective session object identifier corresponding to the session message;
for a session message associated with an organization other than the first organization, displaying session identification information generated based on a respective organization identifier corresponding to the session message.

Optionally, the method further includes:
determining a plurality of session messages within a same organization that satisfy an association condition;
determining an aggregated message generated based on the plurality of session messages; and
displaying the aggregated message according to the first display style corresponding to the organization.

Optionally, the determining the plurality of session messages within the same organization that satisfy the association condition includes:
determining a plurality of session messages associated with a same topic and belonging to the same organization; or, determining a plurality of consecutively displayed session messages belonging to the same organization;
the determining the aggregated message generated based on the plurality of session messages includes:
determining message prompt information generated from the plurality of session messages; determining a card message carrying message prompt information corresponding to the plurality of session messages; or, determining an aggregated message based on a first session message of the plurality of session messages and content of the plurality of session messages;
the displaying the aggregated message according to the first display style corresponding to the organization includes:
displaying the aggregated message as a new message according to the first display style corresponding to the organization; or, updating the plurality of session messages to become the aggregated message.

Optionally, the first display style includes one or more selected from a group consisting of: a message background color, a font type, a font color, a font size, a message marker, and a display area; and wherein displaying, on the message display interface, session messages belonging to different organizations according to the first display style corresponding to each respective organization includes one or more of:
setting session messages belonging to different organizations to different message background colors according to the first display style corresponding to each respective organization;
setting session messages belonging to different organizations to different font types;
setting session messages belonging to different organizations to different font colors;
setting session messages belonging to different organizations to different font sizes;
setting session messages belonging to different organizations to different message markers; and,
displaying session messages belonging to different organizations in different display areas.

Optionally, the displaying, on the message display interface, session messages belonging to different organizations according to a first display style corresponding to each respective organization includes:
displaying, in a first display area of the message display interface, session messages associated with a first organization to which the first session object belongs;
displaying, in a second display area of the message display interface, session messages associated with organizations other than the first organization, wherein the messages from other organizations are displayed according to a third display style corresponding to their respective organization, and wherein the third display styles for different organizations are distinct.

Optionally, the displaying, on the message display interface, session messages belonging to different organizations according to a first display style corresponding to each respective organization includes:
determining the logistics demanding party and the logistics service party to which the plurality of session objects belong;
displaying, on the message display interface, session messages belonging to the logistics demanding party and session messages belonging to the logistics service party according to distinct first display styles.

Optionally, a session message includes a card message generated based on a logistics plan, the method further including:
when the first session object belongs to the logistics demanding party and the card message is from the logistics service party, in response to an order placement operation triggered by the first session object on an order placement control within the card message, sending an order placement request to a server;
when the first session object belongs to the logistics service party and the card message is from the logistics demanding party, in response to an update operation by the first session object concerning the logistics plan, updating the card message.

Optionally, the first session object belongs to the logistics demanding party, the method further including:
receiving a session request sent by the first session object regarding a logistics plan provided by a logistics service party; and
sending the session request to a server, to enable the server to establish the target session connection, the target session connection including the plurality of session objects including the first session object, based on session objects corresponding respectively to the logistics demanding party and the logistics service party.

Optionally, the method further includes:
providing a plan display interface;
displaying, on the plan display interface, plan prompt information and session prompt information for a plurality of logistics plans;
wherein receiving the session request sent by the first session object regarding the logistics plan provided by the logistics service party includes:
in response to a trigger operation on any of the session prompt information, generating the session request for a corresponding logistics service party associated with the triggered session prompt information.

Optionally, the method further includes:
based on the organization division operation of the first session object, determining the at least two organizations to which the plurality of session objects belong.

Optionally, the method further includes:
in response to an export operation on at least one message in the message display interface, generating a message record composed of the at least one session message.

Optionally, the method further includes:
determining the first organization to which the first session object belongs;
generating respective session identification information based on the respective session object identifier corresponding to the different session messages of the first organization;
generating respective session identification information based on the organization identifier of the different session messages of organizations other than the first organization;
sending the session identification information of the first organization and the session identification information of the other organizations to the client device.

Optionally, the method further includes:
determining a plurality of session messages that satisfy an aggregation condition;
controlling the client device to perform aggregated display of the plurality of session messages.

Optionally, the method further includes:
sending a plurality of logistics plans provided by a plurality of logistics service parties for the logistics demanding party's logistics demand to the client device;
based on the session request sent by the client device for any logistics service party, establishing the target session connection including the plurality of session objects including the first session object, based on session objects corresponding respectively to the logistics demanding party and the logistics service party.

Optionally, the session message includes a card message carrying a logistics plan; the method further includes:
when the first session object belongs to the logistics demanding party and the card message is from the logistics service party, receiving the order placement request sent by the client device, and generating a logistics service order based on the order placement request; wherein the order placement request is generated by the client device in response to an order placement operation triggered by the first session object on an order placement control within the card message;
when the first session object belongs to the logistics service party and the card message is from the logistics demanding party, receiving an update request sent by the client device, updating the logistics plan and sending the update result to the client device for the client device to update the card message; wherein the update request is generated by the client device in response to an update operation by the first session object concerning the logistics plan.

Optionally, the displaying, in the session messages of the first organization, the first session message of the first session object and the second session message other than the first session message according to distinct second display styles includes:
setting, in the session messages of the first organization, the first session message of the first session object and the second session message other than the first session message to different font types, to different font colors, to different font sizes, and/or to different message background colors.

Optionally, the method further includes: determining a plurality of session messages of the same organization related to the same logistics plan or the same logistics order or the service contract associated with the same logistics order; based on the plurality of session messages, acquiring a card message carrying message prompt information corresponding to the logistics plan or the logistics order or the service contract;
displaying the card message according to the first display style corresponding to the organization.

In a second aspect, the embodiments of the present application provide a message processing method, including:
determining a target session connection among a plurality of session objects;
determining at least two organizations to which the plurality of session objects belong;
determining a respective first display style for each of the at least two organizations, wherein the first display styles are distinct for different organizations; and
sending the respective first display style for each of the different organizations to a client device of a first session object among the plurality of session objects, to enable the client device to display, on a message display interface, session messages from the different organizations according to their respective first display styles.

Optionally, the method further includes:
determining, in the session messages of the first organization to which the first session object belongs, the first session message of the first session object and the second session message other than the first session message;
determining respective second display styles for the first session message and the second session message; wherein the first session message and the second session message correspond to distinct second display styles;
sending the respective second display styles for the first session message and the second session message to the client device, to enable the client device to display the first session message and the second session message according to their respective second display styles.

In a third aspect, the embodiments of the present application provide a computing device, including a processing component and a storage component;
the storage component storing one or more computer instructions; wherein the one or more computer instructions are configured to be invoked and executed by the processing component to cause the computing device to perform the message display method as described in the first aspect above or to perform the message processing method as described in the second aspect above.

In a fourth aspect, the embodiments of the present application provide a computer-readable storage medium having stored thereon a computer program, wherein the computer program, when executed by a processor of a computer, causes the computer to perform the message display method as described in the first aspect above or to perform the message processing method as described in the second aspect above.

In the embodiments of the present application, a message display interface for a first session object associated with a target session connection is displayed; wherein the target session connection corresponds to a plurality of session objects; based on at least two organizations to which the plurality of session objects belong, session messages belonging to different organizations are displayed on the message display interface according to a first display style corresponding to each respective organization, wherein the first display styles corresponding to the different organizations are distinct. By using distinct first display styles corresponding to different organizations, session messages from different organizations can be effectively distinguished, reducing comprehension cost, helping to improve communication efficiency, and also reducing interaction time and the number of interactions with the device, thereby reducing the impact on device performance.

These and other aspects of the present application will become more readily apparent from the description of the following embodiments.

### BRIEF DESCRIPTION OF THE DRAWINGS

To more clearly illustrate the technical solutions in the embodiments of the present application or in the prior art, the drawings to be used in the description of the embodiments or the prior art will be briefly introduced below. Obviously, the drawings in the following description are some embodiments of the present application, and for those of ordinary skill in the art, other drawings can be obtained based on these drawings without creative efforts.

FIG. 1 shows a schematic structural diagram of an embodiment of a message processing system provided by the present application;

FIG. 2 shows a flowchart of an embodiment of a message display method provided by the present application;

FIG. 3A shows a schematic diagram of a client interface display in a practical application of an embodiment of the present application;

FIG. 3B shows another schematic diagram of a client interface display in a practical application of an embodiment of the present application;

FIG. 4 shows another schematic diagram of a client interface display in a practical application of an embodiment of the present application;

FIG. 5 shows a flowchart of yet another embodiment of a message display method provided by the present application;

FIG. 6 shows a schematic diagram of scene interaction in a practical application of an embodiment of the present application;

FIG. 7 shows a schematic structural diagram of an embodiment of a message display apparatus provided by the present application;

FIG. 8 shows a schematic structural diagram of an embodiment of a message processing apparatus provided by the present application;

FIG. 9 shows a schematic structural diagram of an embodiment of a computing device provided by the present application.

### DETAIL DESCRIPTION OF THE EMBODIMENTS

To enable those skilled in the art to better understand the solutions of the present application, the technical solutions in the embodiments of the present application will be clearly and completely described below in conjunction with the accompanying drawings in the embodiments of the present application.

In some processes described in the specification, claims, and the aforementioned drawings of the present application, a plurality of operations appear in a specific order, but it should be clearly understood that these operations may not be executed in the order in which they appear herein or executed in parallel. The serial numbers of operations, such as 101, 102, etc., are merely used to distinguish different operations, and the serial numbers themselves do not represent any execution order. In addition, these processes may include more or fewer operations, and these operations may be executed sequentially or in parallel. It should be noted that the descriptions of “first,” “second,” etc., herein are used to distinguish different messages, devices, modules, etc., and do not represent a chronological order, nor do they imply that “first”and “second”refer to different types.

The technical solutions of the embodiments of the present application can be applied in communication scenarios involving communication between a plurality of session objects, where the plurality of session objects can establish session connections and belong to a plurality of organizations.

As described in the background art, in communication between organizations, feedback in the name of the organization is sufficient, without needing to identify feedback from a specific person. Compared to communicating via email, using communication tools can establish session channels (i.e., group communication channels) between a plurality of members involved in different organizations, and achieve communication through session messages, which can improve communication convenience.

However, in the process of implementing the present application, the inventors found that in such session connections involving a plurality of personnel, because personnel communicate alternately, and according to traditional group message display methods, session messages are scattered. In each person's message display interface, session messages sent by themselves are often displayed on one side of the interface, while messages from other members are displayed on the other side of the interface, resulting in session messages sent by different personnel from different organizations often being mixed together, making it difficult to distinguish session messages from different organizations, increasing comprehension cost, thereby reducing communication efficiency. It may require repeatedly browsing session messages and spending more time understanding personnel relationships, which leads to increased interaction time and the number of interactions with the device, thereby affecting device performance.

To improve communication efficiency and reduce the impact on device performance, the inventors, through a series of studies, proposed the technical solution of the present application. In the embodiments of the present application, a message display interface for a first session object associated with a target session connection is displayed; wherein the target session connection corresponds to a plurality of session objects; based on at least two organizations to which the plurality of session objects belong, session messages belonging to different organizations are displayed on the message display interface according to distinct first display styles. By displaying session messages from different organizations according to distinct first display styles, session messages from different organizations can be effectively distinguished based on the distinct first display styles, which reduces comprehension cost, helps improve communication efficiency, and also reduces interaction time and the number of interactions with the device, thereby reducing the impact on device performance.

In the embodiments of the present application, a session object refers to a person participating in communication within an organization, corresponding to a communication account to enable network communication.

The technical solutions in the embodiments of the present application will be clearly and completely described below in conjunction with the accompanying drawings in the embodiments of the present application. Obviously, the described embodiments are only a part of the embodiments of the present application, rather than all of them. All other embodiments obtained by those skilled in the art based on the embodiments in the present application without creative efforts shall fall within the protection scope of the present application.

FIG. 1 is a schematic structural diagram of a message processing system in which the technical solution of the embodiments of the present application can be applied. The message processing system may include a plurality of client devices 101 and a server 102. In a practical application, the message processing system can be an instant messaging system, where a plurality of session objects achieve instant messaging through their respective client devices and the server.

The plurality of client devices 101 correspond to different session objects respectively. A session object corresponds to a pre-registered communication account. A plurality of session objects can use communication accounts to establish session connections through their respective client devices and the server to achieve communication based on the session connection. In practical applications, this session connection is implemented as a session group. Each session object can use the client device to send a session message based on the session connection to other client devices via the server for other session objects to view.

For ease of understanding, the technical solution of the embodiments of the present application will be mainly introduced using the first session object 103 and its corresponding client device. The first session object 103 can refer to any one of the aforementioned plurality of session objects.

The plurality of client devices 101 and the server 102 can establish communication connections through a network to achieve session connections for a plurality of session objects. The network provides the medium for communication links. The network may include various connection types, such as wired, wireless communication links, or optical fiber cables, etc. FIG. 1 only exemplarily describes a wireless communication link. Optionally, the server can establish communication connections with a plurality of client devices 101 through a mobile network, etc. Of course, communication connections can also be established through Bluetooth, WiFi, infrared, etc., which is not limited in the present application.

Each of the client devices 101 may be a browser, an App (application), a web application such as H5 (HyperText Markup Language 5) application, a light application (also known as a mini-program, a lightweight application), or a cloud application, etc. The client device 101 can be deployed in an electronic device and needs to rely on the device or certain apps within the device to run. The electronic device, for example, can have a display screen and support information browsing, etc., such as a personal mobile terminal like a mobile phone, a tablet computer, a personal computer, a desktop computer, a smart speaker, a smart watch, etc. For ease of understanding, FIG. 1 mainly represents the receiving end or the sending end in the form of a device. Various other types of applications can usually be configured in the electronic device, such as human-computer dialogue applications, model training applications, text processing applications, web browser applications, shopping applications, search applications, instant messaging tools, email clients, social platform software, etc. An electronic device may refer to a device used by a user, which has functions such as computing, internet access, and communication required by the user, for example, it can be a mobile phone, a tablet computer, a personal computer, a wearable device, etc. An electronic device can usually include a processing component and a storage component. An electronic device may also include basic configurations such as a network card chip, an IO bus, and audio/video components, which are not limited in the present application. Optionally, depending on the implementation form of the electronic device, it may also include some peripheral devices, such as a keyboard, a mouse, an input pen, a printer, etc., which are not limited in the present application.

The server 102 can be implemented as a distributed server cluster composed of a plurality of servers, or it can be implemented as a single server. The server can also be a server of a distributed system, or a server combined with blockchain. The server can also be a cloud server that provides basic cloud computing services such as cloud services, cloud databases, cloud computing, cloud functions, cloud storage, network services, cloud communication, middleware services, domain name services, security services, content delivery networks (CDN), and big data and artificial intelligence platforms, or an intelligent cloud computing server or intelligent cloud host with artificial intelligence technology.

In addition, in one implementation, the client device 101 can be integrated into a main application as a plug-in program or a light application.

The organization involved in the embodiments of the present application can refer to a collection of two or more members acting in concert to achieve a common goal, for example, it can refer to an enterprise, a team, a department, or an institution, etc.

In a practical application, the technical solution of the embodiments of the present application can be applied in logistics service scenarios, where a logistics demanding party needs to communicate and negotiate with a logistics service party regarding logistics plan quotation information, etc., to ultimately purchase logistics services provided by the logistics service party. The aforementioned logistics service party can be responsible for providing transportation, transshipment, loading and unloading logistics services for objects. The aforementioned logistics demanding party can specifically refer to a freight forwarding party (referred to as: freight forwarder), and the freight forwarder can cooperate with a plurality of logistics service parties to provide logistics services corresponding to different physical service stages, etc.

The logistics demanding party and the logistics service party can conduct logistics plan transactions through a logistics service system. The logistics service system can integrate logistics plans provided by a plurality of logistics providers and offer them to the logistics demanding party for online searching and selection. The logistics demanding party can publish logistics demands in the logistics service system, and different logistics service parties can provide logistics plans for the logistics demand for the logistics demanding party to choose from. In this process, the logistics demanding party often needs to communicate with the logistics service party regarding the logistics plan, and adopting the technical solution of the embodiments of the present application can improve communication efficiency.

In addition, the technical solution of the embodiments of the present application can also be applied in application scenarios where a plurality of organizations communicate and negotiate regarding a service object. In addition to the aforementioned logistics plan, the service object can also be, for example, goods, orders, files, contracts, etc., which is not limited in the present application.

The message processing system shown in FIG. 1 can be a logistics service system, or other processing systems associated with the logistics service system, for example, the aforementioned client device 101 can be integrated into the front-end application of the logistics service system, etc.

It should be noted that the embodiments of the present application may involve the use of user data. In practical applications, user-specific personal data can be used in the schemes described herein within the scope permitted by applicable laws and regulations (e.g., with explicit user consent, effective notification to the user, etc.), in compliance with the requirements of applicable laws and regulations in the country where it is used.

It should be noted that the technical solution of the embodiments of the present application is applicable to a network virtual environment, and the described member object generally refers to a “virtual user.” A real user can register an account in the server through registration to obtain a user identity in the network environment.

It should be noted that the message display method provided in the embodiments of the present application is generally executed by the client device 101, and the corresponding message display apparatus is generally set in the client device 101. The message processing method provided in the embodiments of the present application is generally executed by the server 102, and the corresponding message processing apparatus is generally set in the server 102. However, in other embodiments of the present application, the client device 101 can also have similar functions to the server 102, thereby executing the message processing method provided in the embodiments of the present application, etc. In other embodiments, the message processing method provided in the embodiments of the present application can also be jointly executed by the client device 101 and the server 102.

It should be understood that the number of client devices and servers in FIG. 1 is merely illustrative. Any number of client devices and servers can be used according to implementation needs.

The implementation details of the technical solution of the embodiments of the present application are described in detail below.

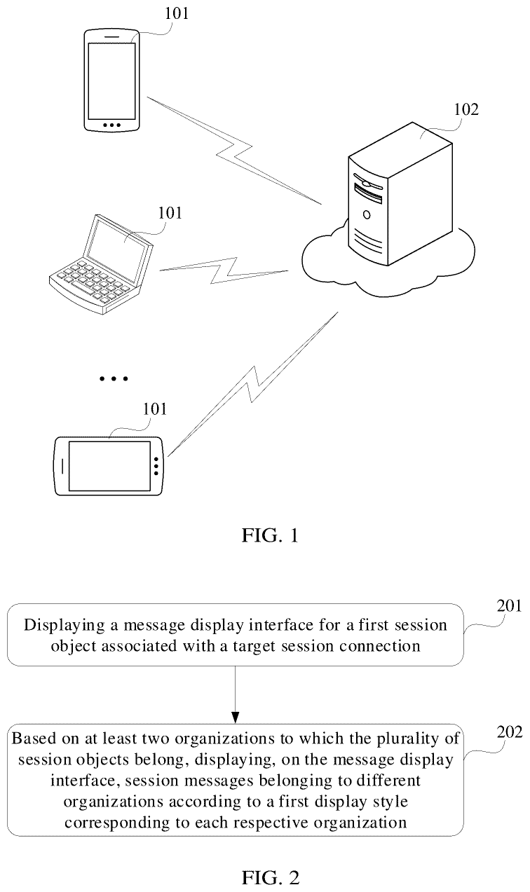

FIG. 2 is a flowchart of an embodiment of a message display method provided by the embodiments of the present application. The method may include the following steps:
S201: displaying a message display interface for a first session object associated with a target session connection; wherein the target session connection corresponds to a plurality of session objects.

A session object refers to the network identity obtained by personnel in an organization through registration. Each session object corresponds to a communication account to distinguish different session objects. The target session connection can refer to any session connection corresponding to a plurality of session objects.

Optionally, a message display interface for the first session object associated with the target session connection can be displayed based on a communication request initiated by the first session object.

The communication request can specifically be a session request for requesting to establish the target session connection, so that the client device can send the communication request to the server. The server can then establish the target session connection corresponding to the plurality of session objects. After the target session connection is established, the client device can display the message display interface corresponding to the first session object.

Certainly, the communication request can also be a viewing request for requesting to view session messages corresponding to an established target session connection, so that the client device can display the message display interface based on the viewing request.

Optionally, the client device can also receive a session message input by the first session object, and send the session message via the server to the client devices corresponding to the other session objects associated with the target session connection, for display on their respective message display interfaces. The session message of the first session object will also be simultaneously displayed on the message display interface corresponding to the first session object.

In addition, the client device can receive a session message sent by a second session object associated with the target session connection from the server, and can display it on the message display interface. The second session object can be any session object different from the first session object.
S202: based on at least two organizations to which the plurality of session objects belong, displaying, on the message display interface, session messages belonging to different organizations according to a first display style corresponding to each respective organization.

The first display styles corresponding to the different organizations are distinct.

In the embodiments of the present application, the plurality of session objects corresponding to the target session connection belong to at least two organizations, and each organization can correspond to one or more session objects. In the embodiments of the present application, the organizations to which the plurality of session objects belong can be determined first, and the first display style corresponding to each organization can be determined, wherein the at least two organizations correspond to distinct first display styles, so that session messages belonging to different organizations can be displayed on the message display interface according to distinct first display styles. The first display style corresponding to session messages of the same organization can be the same. Therefore, based on the first display style corresponding to each organization, session messages of the same organization can be conveniently distinguished, and based on the distinct first display styles corresponding to different organizations, session messages of different organizations can be conveniently distinguished. By adopting the message display method of the embodiments of the present application, comprehension cost can be reduced, communication efficiency can be improved, and interaction time and the number of interactions with the device can also be reduced, thereby reducing the impact on device performance.

To facilitate each session object distinguishing different session objects within the same organization, in some embodiments, the method can further include:
when a session message associated with a first organization, to which the first session object belongs, is displayed using the first display style corresponding to the first organization, displaying a first session message of the first session object and a second session message, different from the first session message but also associated with the first organization, according to distinct second display styles.

The second session message other than the first session message refers to the remaining session messages not including the first session message.

In the embodiments of the present application, for the session messages corresponding to the first organization, the first session message corresponding to the first session object can be displayed distinctly from the remaining session messages, to facilitate the first session object effectively distinguishing the first session message sent by itself and the session messages sent by other session objects, etc., thereby further improving communication efficiency.

Since in scenarios where organizations communicate with each other, one organization does not care which session object sent the session message from another organization, in practical applications, each session message displayed in the message display interface will display corresponding session identification information. Therefore, to further reduce comprehension cost and improve communication efficiency, in some embodiments, the method can further include:
determining the first organization to which the first session object belongs;
for different session messages corresponding to organizations other than the first organization, displaying session identification information generated based on their respective organization identifiers.

Optionally, for different session messages corresponding to the first organization, session identification information generated based on their respective session object identifiers can be displayed.

That is, for the message display interface corresponding to the first session object, different session messages corresponding to the first organization can each display their respective session object identifiers, to facilitate the first session object distinguishing different session objects within the same organization. For other organizations, the first session object does not need to identify the specific session object that sent the message, only the organization it originated from. Therefore, different session messages corresponding to any other organization can display a unified organization identifier, thereby further reducing comprehension cost.

Certainly, the session identification information of the first organization can only include the session object identifier, or it may include the session object identifier corresponding to the session message. The session identification information corresponding to other organizations can only include the organization identifier, or it may also include the session object identifier corresponding to the session message, etc.

In addition, the session identification information may also include basic information such as session time.

In some embodiments, to facilitate message traceability and solve the problem of message dispersion, the method can further include:
determining a plurality of session messages that satisfy an association condition;
determining an aggregated message generated based on the plurality of session messages;
displaying the aggregated message.
displaying the aggregated message according to the first display style corresponding to the organization.

For the same organization, a plurality of session messages satisfying the association condition and corresponding to the same organization can be determined, so that the aggregated message can be displayed according to the first display style corresponding to the organization.

As an optional method, the association condition can be consecutive display, that is, among session messages arranged in chronological order, a plurality of consecutively arranged session messages that all belong to the same organization and have no other organizations inserted between them are considered to satisfy the association condition. Therefore, this can involve determining a plurality of consecutively displayed session messages corresponding to the same organization.

In addition, as another optional method, the association condition can also be that the session time meets the time requirement, for example, the time difference between the session time and the current time is within a specified time range, such as session messages with a session time 1 hour after the current time are considered to satisfy the aggregation condition.

In addition, as yet another optional method, the association condition can be that the session time meets the time requirement and consecutive display. Therefore, this can involve determining a plurality of session messages corresponding to the same organization whose session time meets the time requirement and are consecutively displayed.

In addition, as yet another optional method, the association condition can be related to the same topic. Therefore, this can involve determining a plurality of session messages related to the same topic and corresponding to the same organization.

In practical applications, the technical solution of the embodiments of the present application can be applied in application scenarios where a plurality of organizations communicate regarding a service object. The service object can be, for example, a logistics plan, goods, an order, a file, or a contract, etc. The topic can specifically refer to any service object, thereby achieving the purpose of aggregated display of a plurality of session messages related to the same service object.

As an optional method, determining the aggregated message generated based on the plurality of session messages can be: determining message prompt information generated based on the plurality of session messages.

The message prompt information can be generated based on at least part of the first session message, etc. Certainly, it can also be generated based on key information or summary information from a plurality of session messages. In addition, when the topic is a service object, it can also be generated in conjunction with the current state of the service object, etc., which is not limited in the present application.

As another optional method, determining the aggregated message generated based on the plurality of session messages can be: determining a card message carrying message prompt information corresponding to the plurality of session messages.

That is, the message prompt information can be carried in a card message. In addition, the card message may also include some operational controls, such as a view control. Optionally, in response to a trigger operation on the view control, the plurality of session messages can be displayed on a specified page.

In addition, if the plurality of session messages correspond to the same service object, relevant information of the service object can also be displayed on a specified page. For example, if the service object is an order, the relevant information may include order detail information, etc. If the service object is a file, the relevant information may include file content, etc.

As yet another optional method, determining the aggregated message generated based on the plurality of session messages can be: determining an aggregated message generated based on the session identification information corresponding to the first session message among the plurality of session messages and the content of the plurality of session messages.

An aggregated message can be generated by retaining the session identification information corresponding to the first session message in the plurality of session messages and deleting the session identification information corresponding to the remaining session messages other than the first session message.

The first session message can refer to the session message that is ranked first in chronological order among the plurality of session messages.

Through aggregated messages, the complexity of message display can be reduced, and information can be displayed in a flat, aggregated form, which facilitates message tracing.

In addition, in some embodiments, displaying the aggregated message according to the first display style corresponding to the organization includes:
displaying the aggregated message as a new message according to the first display style corresponding to the organization; or, updating the plurality of session messages to become the aggregated message.

That is, the aggregated message can be displayed as an automatically generated new message. Certainly, it can also replace the plurality of session messages for display.

Optionally, in some embodiments, if the aggregated message includes message prompt information, the method may also include: in response to a trigger operation on the message prompt information, displaying a plurality of session messages. In addition, when displaying a plurality of session messages, the session identification information corresponding to the first session message among the plurality of session messages can be retained, and the session identification information corresponding to the remaining session messages other than the first session message can be deleted.

Optionally, in some embodiments, if the aggregated message is a card message, the method may also include: in response to a trigger operation on the card message, the plurality of session messages can be displayed on a specified page.

In addition, if the plurality of session messages correspond to the same service object, relevant information of the service object can also be displayed on a specified page. For example, if the service object is an order, the relevant information may include order detail information, etc. If the service object is a file, the relevant information may include file content, etc.

In some embodiments, the first display style may include one or more selected from a message background color, a font type, a font color, a font size, a message marker, and a display area, etc. The message background color can refer to the color of the message carrying area, the font type may include, for example, kaiti, songti, etc., the message marker can refer to a display identifier set for a session message, which can be a graphic with a certain color and/or a certain shape, etc. The display area can be obtained by dividing the message display interface. Therefore, displaying, on the message display interface, session messages belonging to different organizations according to the first display style corresponding to each respective organization includes one or more of the following implementation methods:
setting session messages belonging to different organizations to different message background colors according to the first display style corresponding to each respective organization;
setting session messages belonging to different organizations to different font types;
setting session messages belonging to different organizations to different font sizes;
setting session messages belonging to different organizations to different message markers; and,
displaying session messages belonging to different organizations in different display areas.

In some embodiments, the second display style may include one or more of a message background color, a font type, a font color, a font size, and a message marker, etc.

Therefore, the displaying, in the session messages of the first organization to which the first session object belongs, the first session message of the first session object and the second session message other than the first session message according to distinct second display styles includes:
setting, in the session messages of the first organization, the first session message of the first session object and the second session message other than the first session message to different font types, to different font colors, to different font sizes, and/or to different message background colors.

The second display style can be different from the first display style to avoid confusion. For example, the first display style may include the display area, and the second display style may include the font color, etc.

When a plurality of session objects belong to two corresponding organizations, the message display interface can be divided into a first display area and a second display area; the first display area can be located at a first boundary of the message display interface, and the second display area can be located at a second boundary of the message display interface, and the first boundary and the second boundary are opposite.

In addition, in some embodiments, the displaying, on the message display interface, session messages belonging to different organizations according to a first display style corresponding to each respective organization includes:
displaying, in a first display area of the message display interface, different session messages associated with the first organization to which the first session object belongs;
displaying, in a second display area of the message display interface, different session messages associated with organizations other than the first organization, and displaying them according to a third display style corresponding to their respective organization; wherein the third display styles for different organizations are distinct.

That is, for the message display interface seen by each session object, session messages corresponding to session objects belonging to the same organization can all be displayed in the same display area. Session messages from other organizations not belonging to the same organization can be displayed in the same display area.

The other organizations apart from the first organization may include one or more organizations.

The message display interface can be divided into a first display area and a second display area; the first display area can be located at a first boundary of the message display interface, and the second display area can be located at a second boundary of the message display interface, and the first boundary and the second boundary are opposite.

When the other organizations include a plurality of organizations, the plurality of organizations can display their respective session messages according to distinct third display styles. The third display style may include, for example, one or more of the following implementation methods:
setting session messages belonging to different organizations to different message background colors according to the first display style corresponding to each respective organization;
setting session messages belonging to different organizations to different font types;
setting session messages belonging to different organizations to different font sizes;
and, setting session messages belonging to different organizations to different message markers, etc.

The at least two organizations to which the plurality of session objects belong can be determined based on the registration information of the plurality of session objects. In addition, optionally, it can also be specified and determined by any session object. Therefore, in some embodiments, the method may also include: based on the organization division operation of the first session object, determining the organizations to which the plurality of session objects belong respectively.

Thereby, for each session object, the organizations to which different session objects belong can be determined according to the organization division method corresponding to each session object, achieving that in the message display interface of each session object, session messages from different organizations can be distinguished and displayed according to different first display styles based on their respective organization division methods.

In some embodiments, the method can further include:

In response to an export operation on at least one message in the message display interface, generating a message record composed of the at least one session message.

The message record can be saved to a local file, or it can be uploaded to a specific network storage system, etc. The message record can be used as a session credential for processing.

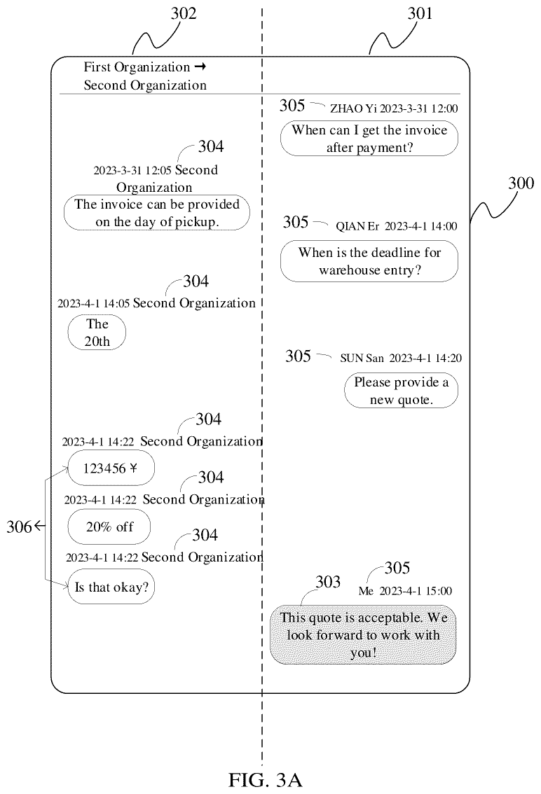

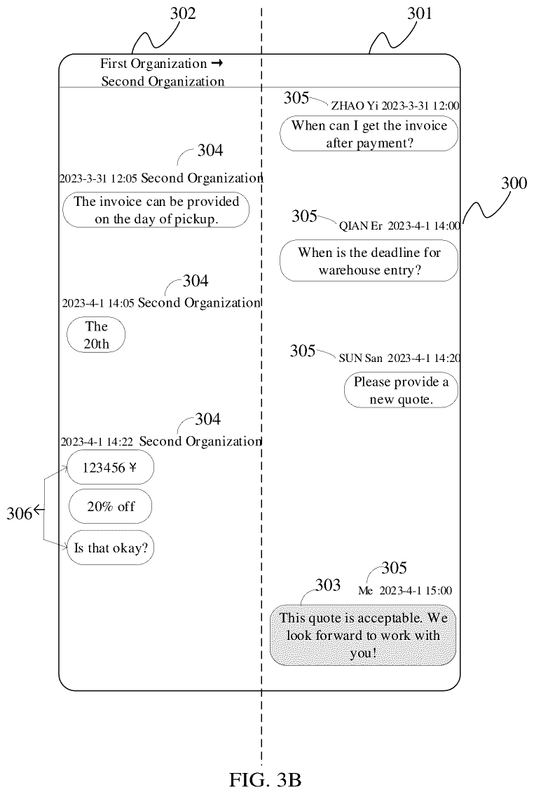

To facilitate understanding, the technical solution of the embodiments of the present application will be introduced below using a communication scenario between two organizations as an example, combined with the schematic diagrams of the message display interface shown in FIGS. 3A to 3B. Assume that a plurality of session objects involved in a first organization and a second organization have established a target session connection, and the first session object can belong to the first organization.

As shown in FIG. 3A, the first organization and the second organization can correspond to different display areas in the message display interface 300. For example, the first organization corresponds to the first display area 301, and the second organization corresponds to the second display area 302. The first display area 301 and the second display area 302 can be obtained by dividing the message display interface in the vertical direction. The first display area and the second display area are each located at two boundary positions of the message display interface. Thereby, session messages belonging to the first organization can be displayed in the first display area 301, near the first boundary, and session messages of the second organization can be displayed in the second display area 302, near the second boundary. Thereby, session messages from different organizations can be quickly distinguished based on the different display areas. Certainly, the session messages of the first organization and the session messages of the second organization can also be set to different font colors, different font types, or different font sizes, etc., to distinguish session messages from different organizations. FIG. 3A is merely an example.

To facilitate the first session object distinguishing different session objects in the first organization, among the session messages of the first organization, the message background color of the session message 303 corresponding to the first session object can be set to be different from the message background color of the second session message. Certainly, different font colors, font types, and/or font sizes, etc. can also be used to distinguish the first session message of the first session object. FIG. 3A is merely an example.

Since the first session object only pays attention to session messages from the second organization, and does not care which session object in the second organization the session message came from. Therefore, as shown in FIG. 3A, the session identification information of the session messages of the second organization can be uniformly displayed as the organization identifier 304 of the second organization, such as “second organization.” The session identification information of the session messages of the first organization can display their corresponding session object identifiers 305, such as “zhao yi,” “qian er,” “sun san,” etc. The session object identifier corresponding to the first session object can be set to “me.”

In addition, for a plurality of consecutively displayed session messages that belong to the same organization and whose session time meets the time requirement, such as after 1 hour, they can be aggregated and displayed. As shown in FIG. 3B, the plurality of session messages 306 in FIG. 3A can be aggregated and displayed in the display form shown in FIG. 3B, that is, only the session identification information of the first session message is retained.

Certainly, the plurality of session messages can also be first converted into message prompt information. If a trigger operation on the message prompt information is responded to, the plurality of session messages can then be displayed in the display form of FIG. 3B.

From the preceding description, it can be seen that the technical solution of the embodiments of the present application can be applied in logistics service scenarios, in scenarios where a logistics demanding party and a logistics service party communicate, and both the logistics demanding party and the logistics service party may have a plurality of members participating in the communication. Therefore, in some embodiments, based on at least two organizations to which the plurality of session objects belong, displaying, on the message display interface, session messages belonging to different organizations according to a first display style corresponding to each respective organization may include:
determining the logistics demanding party and the logistics service party to which the plurality of session objects belong;
displaying, on the message display interface, session messages belonging to the logistics demanding party and session messages belonging to the logistics service party according to distinct first display styles.

In some embodiments, the target session connection can be established based on a session request initiated by any session object among the logistics demanding party or the logistics service party for a logistics plan provided by the logistics service party.

Taking the first session object initiating a session request as an example, the method may also include:
receiving a session request sent by the first session object regarding a logistics plan provided by a logistics service party;
sending the session request to a server, to enable the server to establish the target session connection including the plurality of session objects including the first session object, based on session objects corresponding respectively to the logistics demanding party and the logistics service party.

Optionally, plan prompt information for logistics plans provided by different logistics service parties can be displayed on a logistics plan list page. In addition, corresponding session prompt information can also be displayed. The session request can be generated based on a trigger operation by the first session object on the session prompt information. Therefore, the method may also include:
providing a plan display interface;
displaying, on the plan display interface, plan prompt information and session prompt information for a plurality of logistics plans;
the aforementioned receiving the session request sent by the first session object regarding the logistics plan provided by the logistics service party includes:
in response to a trigger operation on any of the session prompt information, generating the session request for a corresponding logistics service party associated with the triggered session prompt information.

The plurality of logistics plans can be provided by different logistics service parties for the logistics demand published by the logistics demanding party. The logistics demand can also be displayed on the plan display interface. For example, the logistics demand may include logistics routes such as the origin and destination. In addition, it may also include logistics type, cargo weight, etc. The logistics plan may include quotation information such as transportation price and transportation timeliness corresponding to the logistics route.

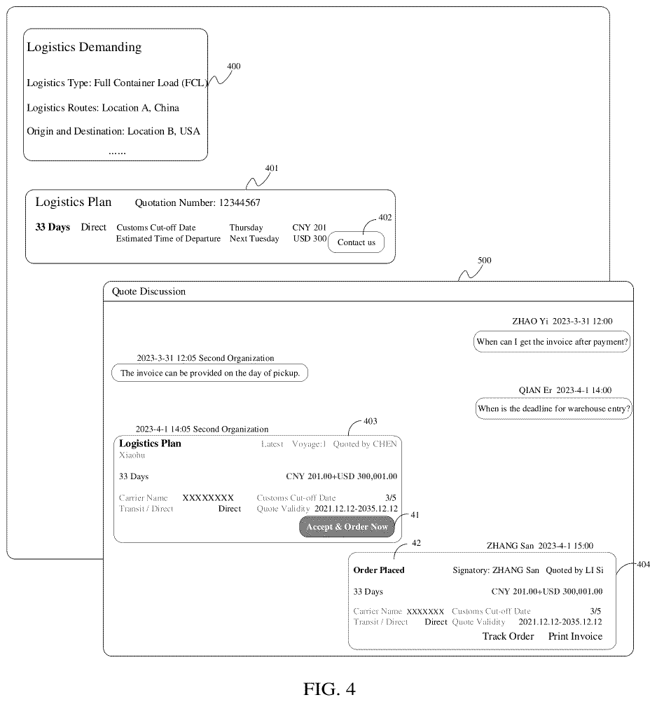

As shown in the plan display interface in FIG. 4, it may include plan prompt information 401 for the logistics plans provided by different logistics service parties for the logistics demand 400. The plan prompt information 401 may include the logistics plan. In addition, corresponding session prompt information 402 can also be displayed.

In response to a trigger operation on the session prompt information 402, a session request can be generated and sent to the server. The server establishes a target session connection for the plurality of session objects corresponding to the logistics demanding party and the logistics service party, and displays a message display interface 500.

Optionally, the message display interface 500 can be displayed overlaid on the plan display interface, or it can switch to the message display interface for display, which is not limited in the present application.

In the message display interface 500, messages can be displayed according to the technical solution of the embodiments of the present application. The specific display forms can be seen in FIG. 3A to 3B, and will not be repeated here.

In addition, a logistics demanding party may communicate with a plurality of logistics service parties, and a logistics service party may also communicate with a plurality of logistics demanding parties. The session connection between the logistics demanding party and the logistics service party can be distinguished by the plan identifier of the corresponding logistics plan, which is not limited in the present application.

The message type of the session message may include text, images, etc. In addition, it may also include a card message. A card message is a message type that carries information in a card, and the card is a carrier of information, which can carry at least one type of information from various types of information such as text, media, interactive components, etc. The card is displayed in the message display interface in the form of a view control or a page to show the information it carries. In one embodiment, the card can be in a block shape, for example, a rectangular display area, to display the carried information after integration. For example, the carried information can be integrated in an agreed manner, and by integrating the carried information, the information can be made more organized and visually more personalized. Through card messages, rich text styles and graphic layout modules can be provided, such as eye-catching notifications, richly illustrated article lists, etc., allowing important information to better reach users. In addition, the interactive components in card messages can provide quick access to operations for users to perform, and users only need simple click or input operations to quickly achieve corresponding processing operations without leaving the current display interface, such as OA (office automation) approval, voting statistics, alarm processing, and other processing operations.

In a logistics service scenario, a card message can be generated based on a logistics plan. The card message can be generated by the logistics demanding party in response to a message sending operation for any logistics plan provided by a logistics service party. Based on the message sending operation, a card message can be generated based on the logistics plan and sent to the target session connection.

The card message may include an exchange control to facilitate directly triggering corresponding processing operations.

Therefore, in some embodiments, the method can further include:

When the first session object belongs to the logistics demanding party and the card message is from the logistics service party, in response to an order placement operation triggered by the first session object on an order placement control within the card message, sending an order placement request to a server;

When the first session object belongs to the logistics service party and the card message is from the logistics demanding party, in response to an update operation by the first session object concerning the logistics plan, updating the card message.

That is, if the card message belongs to the logistics service party, and the first session object belongs to the logistics demanding party, the card message may include an order placement control. The first session object can operate the order placement control to place an order for the logistics plan, etc., thereby enabling quick order placement operations through the technical solution of the embodiments of the present application.

If the card message belongs to the logistics demanding party, and the first session object belongs to the logistics service party, the card message may include an update control. The first session object can operate the update control to update the logistics plan, for example, modifying the transportation price, and can update the card message based on the updated logistics plan.

As shown in the card message 403 in FIG. 4, it may include an order placement control 41.

In response to the order placement request, the server can generate a logistics service order based on the logistics plan. The logistics service order can be sent to the logistics service party to notify the logistics service party to provide corresponding logistics services. In addition, according to the logistics service order, a session message corresponding to the first session object can also be generated and sent to the target session connection. This session message may also be a card message generated based on the logistics service order, as shown in the card message 404 in FIG. 4, etc., and an order placement success prompt information 42 can be displayed in the card message 404.

In addition, order tracking operations can also be performed for the logistics order, such as formulating a service contract, etc. The service contract can also generate corresponding card messages for display on the message display interface. Subsequently, further session communication can be conducted for the logistics order or service contract. Therefore, in some embodiments, the method can further include: determining a plurality of session messages of the same organization related to the same logistics plan or the same logistics order or the service contract associated with the same logistics order; determining an aggregated message generated based on the plurality of session messages; displaying the aggregated message according to the first display style corresponding to the organization.

The aggregated message can be a card message carrying message prompt information corresponding to the logistics plan or the logistics order or the service contract;
wherein the plurality of session messages associated with the logistics plan may include the card message generated based on the service order, and the card message generated based on the service contract, etc.

Further viewing operations can be performed on the aggregated message, such as displaying a plurality of session messages and relevant information about the service order or logistics plan on a designated page.

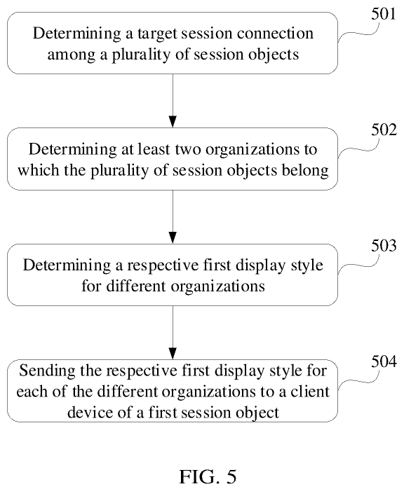

FIG. 5 is a flowchart of an embodiment of a message processing method provided by the embodiments of the present application. This embodiment introduces the technical solution of the present application from the perspective of the server. The method may include the following steps:
S501: determining a target session connection among a plurality of session objects.
S502: determining at least two organizations to which the plurality of session objects belong.
S503: determining a respective first display style for different organizations; wherein the first display styles corresponding to the different organizations are distinct.
S504: sending the respective first display style for each of the different organizations to a client device of a first session object.

The client device can display session messages from different organizations on the message display interface according to their respective first display styles.

In some embodiments, the method can further include:
determining, in the session messages of the first organization to which the first session object belongs, the first session message of the first session object and the second session message other than the first session message;
determining respective second display styles for the first session message and the second session message; wherein the first session message and the second session message correspond to distinct second display styles;
sending the respective second display styles for the first session message and the second session message to the client device, to enable the client device to display the first session message and the second session message according to their respective second display styles.

In some embodiments, the method can further include:
determining the first organization to which the first session object belongs; generating respective session identification information based on the respective session object identifier corresponding to the different session messages of the first organization; generating respective session identification information based on the organization identifier of the different session messages of organizations other than the first organization; sending the session identification information of the first organization and the session identification information of the other organizations to the client device.

The client device can display, on the message display interface, for different session messages corresponding to the first organization to which the first session object belongs, session identification information generated based on their respective session object identifiers. For different session messages corresponding to organizations other than the first organization, session identification information generated based on their respective organization identifiers can be displayed.

In addition, in some embodiments, the method can further include:
determining a plurality of session messages that satisfy an association condition;
generating an aggregated message based on the plurality of session messages;
sending the aggregated message to the client device, to enable the client device to display the aggregated message.

In addition, an aggregation display instruction can also be sent to the client device to instruct the client device to display the aggregated message in an aggregated display manner. For example, it can be displayed as a new message; or, the plurality of session messages can be updated to the aggregated message, that is, the plurality of session messages can be replaced by the aggregated message for display.

Generating an aggregated message based on the plurality of session messages may include:
generating message prompt information based on the plurality of session messages;
generating a card message carrying message prompt information corresponding to the plurality of session messages based on the plurality of session messages;
or, generating an aggregated message based on the session identification information corresponding to the first session message among the plurality of session messages and the content of the plurality of session messages.

In some embodiments, determining a plurality of session messages that satisfy an aggregation condition can be determining a plurality of session messages that are consecutively displayed and belong to the same organization, and/or whose session time meets the session requirements.

In some embodiments, the first display style includes one or more selected from a message background color, a font type, a font color, a font size, a message marker, and a display area;
wherein different first display styles corresponding to different organizations may include one or more of the following implementation methods:
setting session messages of different organizations to different message background colors;
setting session messages of different organizations to different font types;
setting session messages of different organizations to different font colors;
setting session messages of different organizations to different font sizes;
setting session messages of different organizations to different message markers; and,
displaying session messages of different organizations in different display areas, etc.

In some embodiments, different second display styles corresponding to the first session message and the second session message may include, for example, different font types, font colors, font sizes, and/or message background colors.

In some embodiments, as described above, the technical solution of the embodiments of the present application can be applied in logistics service scenarios, and the method can further include:
sending a plurality of logistics plans provided by a plurality of logistics service parties for the logistics demanding party's logistics demand to the client device;
based on the session request sent by the client device for any logistics service party, establishing the target session connection including the plurality of session objects including the first session object, based on session objects corresponding respectively to the logistics demanding party and the logistics service party.

In some embodiments, determining at least two organizations to which the plurality of session objects belong includes: determining the logistics demanding party and the logistics service party to which the plurality of session objects belong.

In some embodiments, the session message may include a card message generated based on a logistics plan; the method can further include:
when the first session object belongs to the logistics demanding party and the card message is from the logistics service party, receiving the order placement request sent by the client device, and generating a logistics service order based on the order placement request; wherein the order placement request is generated by the client device in response to an order placement operation triggered by the first session object on an order placement control within the card message;
when the first session object belongs to the logistics service party and the card message is from the logistics demanding party, receiving an update request sent by the client device, updating the logistics plan and sending the update result to the client device for the client device to update the card message; wherein the update request is generated by the client device in response to an update operation by the first session object concerning the logistics plan.

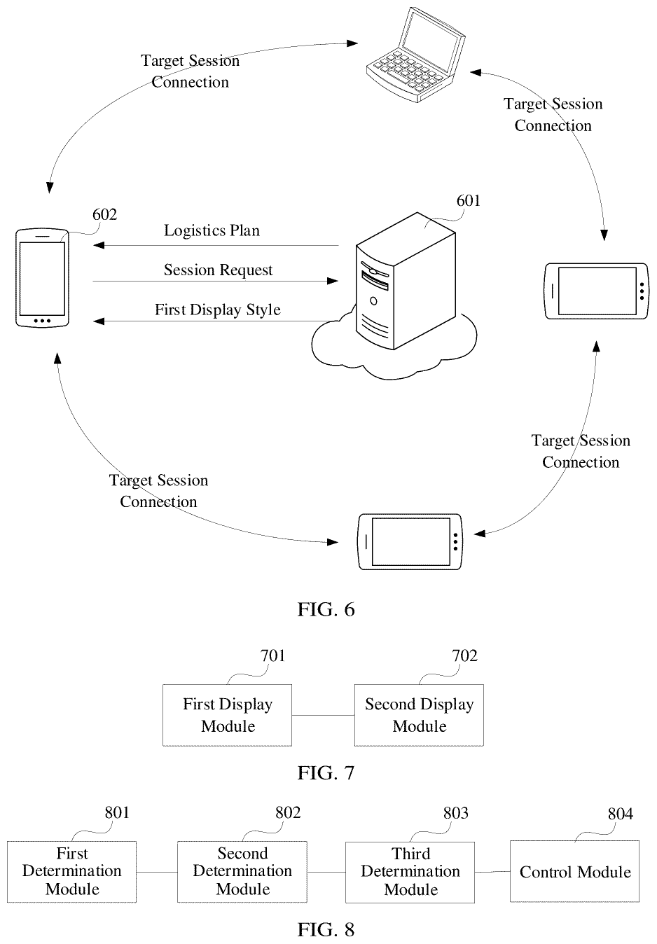

FIG. 6 shows a schematic diagram of scene interaction in a practical application of the technical solution of the embodiments of the present application. Taking a logistics service scenario as an example, assume that the first session object belongs to the logistics demanding party. Certainly, the first session object can also belong to the logistics service party.

The server 601 can notify a plurality of logistics service parties of the logistics demand of the logistics demanding party, so that a plurality of logistics service parties can provide logistics plans for the logistics demand. The logistics demand may include, for example, the origin and the destination. In addition, it may also include the logistics type, cargo weight, etc. The logistics plan may include the origin, destination, etc., and also information such as transportation price and transportation timeliness.

The server 601 can send the logistics plans provided by a plurality of logistics service parties to the client device 602 of the first session object. The client device 602 can display plan prompt information and session prompt information for a plurality of logistics plans on the plan display interface.

The first session object can trigger a session request to the server 601 through the client device 602 for any session prompt information. Certainly, the session request can also be initiated by any session object within the logistics demanding party. In practical applications, the logistics demand, session request, session messages, etc., can be sent by different session objects of the logistics demanding party. For ease of understanding and description, the present application takes the first session object as an example for illustration.

The server 601 establishes a target session connection for the plurality of session objects involved in the logistics demanding party and the logistics service party based on the session request. The plurality of session objects can then send session messages based on the target session connection. The session messages can be sent via the server 601 to the client devices corresponding to each session object, etc.

The client device 602 can display the message display interface of the first session object.

The server 601 can determine the logistics demanding party or logistics service party to which the plurality of session objects belong, and determine that the logistics demanding party and the logistics service party correspond to distinct first display styles, so that the distinct first display styles corresponding to the logistics demanding party and the logistics service party can be sent to the client devices corresponding to each session object. The embodiments of the present application illustrate with the client device 602 corresponding to the first session object as an example. The client device 602 can display their respective session messages according to the distinct first display styles corresponding to the logistics demanding party and the logistics service party. For session messages of the same organization, the session messages of the first session object can be displayed distinctly from the remaining session messages according to distinct second display styles. In addition, for the first session object, the session identification information of the session messages of the logistics service party can be uniformly set as the organization identifier of the logistics service party, such as the logistics service party name, etc., while the session messages of the logistics demanding party can be set as their respective session object identifiers, etc. In addition, the client device 602 can also perform aggregated display of a plurality of session messages that satisfy the aggregation condition. The specific display forms can be found in FIGS. 3A to 3B, and will not be repeated here.

FIG. 7 is a schematic structural diagram of an embodiment of a message display apparatus provided by the embodiments of the present application. The apparatus may include:
a first display module 701, used for displaying a message display interface for a first session object associated with a target session connection; wherein the target session connection corresponds to a plurality of session objects;
a second display module 702, used for, based on at least two organizations to which the plurality of session objects belong, displaying, on the message display interface, session messages belonging to different organizations according to a first display style corresponding to each respective organization. The first display styles corresponding to the different organizations are distinct.

In some embodiments, the second display module is further used for, when a session message associated with a first organization, to which the first session object belongs, is displayed using the first display style corresponding to the first organization, displaying a first session message of the first session object and a second session message, different from the first session message but also associated with the first organization, according to distinct second display styles.

In some embodiments, the second display module is further used for, for a session message associated with a first organization to which the first session object belongs, displaying session identification information generated based on a respective session object identifier corresponding to the session message;
for a session message associated with an organization other than the first organization, displaying session identification information generated based on a respective organization identifier corresponding to the session message.

In some embodiments, the second display module is further used for determining a plurality of session messages that satisfy an association condition; determining an aggregated message generated based on the plurality of session messages; and displaying the aggregated message according to the first display style corresponding to the organization.

In some embodiments, the second display module determining a plurality of session messages that satisfy an association condition includes: determining a plurality of session messages associated with a same topic and belonging to the same organization; or, determining a plurality of consecutively displayed session messages belonging to the same organization;
the second display module determining the aggregated message generated based on the plurality of session messages includes: determining message prompt information generated from the plurality of session messages; determining a card message carrying message prompt information corresponding to the plurality of session messages; or, determining an aggregated message based on a first session message of the plurality of session messages and content of the plurality of session messages;
the second display module displaying the aggregated message according to the first display style corresponding to the organization includes: displaying the aggregated message as a new message according to the first display style corresponding to the organization; or, updating the plurality of session messages to become the aggregated message.

Determining a plurality of session messages that satisfy the aggregation condition for any organization includes: determining a plurality of consecutively displayed session messages that belong to the same organization;
the second display module aggregating and displaying a plurality of session messages includes: retaining the session identification information corresponding to the first session message among the plurality of session messages and deleting the session identification information corresponding to the remaining session messages other than the first session message; or, updating the plurality of session messages to the message prompt information corresponding to the plurality of session messages.

In some embodiments, the first display style includes one or more selected from a message background color, a font type, a font color, a font size, a message marker, and a display area; the second display module displaying, on the message display interface, session messages belonging to different organizations according to a first display style corresponding to each respective organization includes one or more of the following implementation methods:
setting session messages belonging to different organizations to different message background colors according to the first display style corresponding to each respective organization;
setting session messages belonging to different organizations to different font types;
setting session messages belonging to different organizations to different font colors;
setting session messages belonging to different organizations to different font sizes;
setting session messages belonging to different organizations to different message markers;
and,
displaying session messages belonging to different organizations in different display areas.

In some embodiments, the second display module can specifically determine the logistics demanding party and the logistics service party to which the plurality of session objects belong; and display, on the message display interface, session messages belonging to the logistics demanding party and session messages belonging to the logistics service party according to distinct first display styles.

In some embodiments, a session message includes a card message generated based on a logistics plan; the apparatus can further include:
a first processing module, used for, when the first session object belongs to the logistics demanding party and the card message is from the logistics service party, in response to an order placement operation triggered by the first session object on an order placement control within the card message, sending an order placement request to a server; and when the first session object belongs to the logistics service party and the card message is from the logistics demanding party, in response to an update operation by the first session object concerning the logistics plan, updating the card message.

In some embodiments, the first display module can specifically receive a session request sent by the first session object regarding a logistics plan provided by a logistics service party;
send the session request to a server, to enable the server to establish the target session connection including the plurality of session objects including the first session object, based on session objects corresponding respectively to the logistics demanding party and the logistics service party.

In some embodiments, the first display module is further used for providing a plan display interface; displaying, on the plan display interface, plan prompt information and session prompt information for a plurality of logistics plans;
the first display module receiving the session request sent by the first session object regarding the logistics plan provided by the logistics service party may include: in response to a trigger operation on any of the session prompt information, generating the session request for a corresponding logistics service party associated with the triggered session prompt information.

In some embodiments, the second display module can specifically set, in the session messages of the first organization, the first session message of the first session object and the second session message other than the first session message to different font types, to different font colors, to different font sizes, and/or to different message background colors.

The message display apparatus described in FIG. 7 can execute the message display method described in the embodiment shown in FIG. 2, and its implementation principle and technical effects will not be repeated. The specific methods for each module and unit in the above-described embodiments of the message display apparatus to perform operations have been described in detail in the embodiments related to the method, and will not be described in detail here.

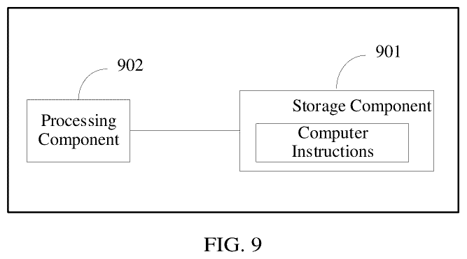

FIG. 8 is a schematic structural diagram of an embodiment of a message processing apparatus provided by the embodiments of the present application. The apparatus may include:
a first determination module 801, used for determining a target session connection among a plurality of session objects;
a second determination module 802, used for determining at least two organizations to which the plurality of session objects belong;
a third determination module 803, used for determining a respective first display style for different organizations; wherein the first display styles corresponding to the different organizations are distinct;
a control module 804, used for sending the respective first display style for each of the different organizations to a client device of a first session object, to enable the client device to display, on a message display interface, session messages from the different organizations according to their respective first display styles.

In some embodiments, the apparatus can further include:
a fourth determination module, used for determining, in the session messages of the first organization to which the first session object belongs, the first session message of the first session object and the second session message other than the first session message; determining respective second display styles for the first session message and the second session message; wherein the first session message and the second session message correspond to distinct second display styles.

The control module is further used for sending the respective second display styles for the first session message and the second session message to the client device, to enable the client device to display the first session message and the second session message according to their respective second display styles.

In some embodiments, the apparatus can further include:
a fifth determination module, used for determining the first organization to which the first session object belongs; generating respective session identification information based on the respective session object identifier corresponding to the different session messages of the first organization; generating respective session identification information based on the organization identifier of the different session messages of organizations other than the first organization.

The control module is further used for sending the session identification information of the first organization and the session identification information of the other organizations to the client device.

In some embodiments, the control module is further used for determining a plurality of session messages that satisfy an aggregation condition; controlling the client device to perform aggregated display of the plurality of session messages.

In some embodiments, the apparatus can further include:
a session establishment module, used for sending a plurality of logistics plans provided by a plurality of logistics service parties for the logistics demanding party's logistics demand to the client device; based on the session request sent by the client device for any logistics service party, establishing the target session connection including the plurality of session objects including the first session object, based on session objects corresponding respectively to the logistics demanding party and the logistics service party.

In some embodiments, the second determination module can be used for determining the logistics demanding party and the logistics service party to which the plurality of session objects belong.

In some embodiments, a session message includes a card message carrying a logistics plan; the apparatus can further include:
a second processing module, used for, when the first session object belongs to the logistics demanding party and the card message is from the logistics service party, receiving the order placement request sent by the client device, and generating a logistics service order based on the order placement request; wherein the order placement request is generated by the client device in response to an order placement operation triggered by the first session object on an order placement control within the card message; and when the first session object belongs to the logistics service party and the card message is from the logistics demanding party, receiving an update request sent by the client device, updating the logistics plan and sending the update result to the client device for the client device to update the card message; wherein the update request is generated by the client device in response to an update operation by the first session object concerning the logistics plan.

The message processing apparatus described in FIG. 8 can execute the message processing method described in the embodiment shown in FIG. 5, and its implementation principle and technical effects will not be repeated. The specific methods for each module and unit in the above-described embodiments of the message display apparatus to perform operations have been described in detail in the embodiments related to the method, and will not be described in detail here.

The embodiments of the present application also provide a computing device. As shown in FIG. 9, the device may include a storage component 901 and a processing component 902;
the storage component 901 stores one or more computer instructions, wherein the one or more computer instructions are for being invoked and executed by the processing component 902 to implement the message display method as described in the embodiment shown in FIG. 2 or the message processing method as described in the embodiment shown in FIG. 5.

Certainly, the computing device will inevitably include other components, such as input/output interfaces, communication components, etc.

If the processing component in the computing device is used to implement the message display method shown in FIG. 2, the computing device may also include a display component to perform corresponding display operations.

The input/output interface provides an interface between the processing component and peripheral interface modules, and the peripheral interface modules can be output devices, input devices, etc. The communication component is configured to facilitate wired or wireless communication between the computing device and other devices.

The processing component 902 may include one or more processors to execute computer instructions to complete all or part of the steps in the above method. Certainly, the processing component can also be implemented by one or more application-specific integrated circuits (ASIC), digital signal processors (DSP), digital signal processing devices (DSPD), programmable logic devices (PLD), field programmable gate arrays (FPGA), controllers, microcontrollers, microprocessors, or other electronic components, for executing the above method.

The storage component 901 is configured to store various types of data to support operations on the terminal. The storage component can be implemented by any type of volatile or non-volatile storage device or a combination thereof, such as static random access memory (SRAM), electrically erasable programmable read-only memory (EEPROM), erasable programmable read-only memory (EPROM), programmable read-only memory (PROM), read-only memory (ROM), magnetic storage, flash memory, disk or optical disk.

The display component can be an electroluminescent (EL) element, a liquid crystal display or a micro-display with a similar structure, or a direct retinal display or similar laser scanning display.

It should be noted that when the above computing device implements the message processing method described in the embodiment shown in FIG. 5, it can be a physical device or an elastic computing host provided by a cloud computing platform, etc. It can be implemented as a distributed cluster composed of a plurality of servers or terminal devices, or it can be implemented as a single server or a single terminal device.

When the above computing device implements the message display method described in the embodiment shown in FIG. 2, it can be specifically implemented as an electronic device. An electronic device can refer to a device used by a user, which has functions such as computing, internet access, and communication required by the user, for example, it can be a mobile phone, a tablet computer, a personal computer, a wearable device, etc.

The embodiments of the present application also provide a computer-readable storage medium storing a computer program, wherein the computer program, when executed by a computer, can implement the message display method of the embodiment shown in FIG. 2 above or the message processing method of the embodiment shown in FIG. 5. The computer-readable medium may be included in the electronic device described in the above embodiments; or it can exist independently and not be assembled into the electronic device.

The embodiments of the present application also provide a computer program product, which includes a computer program carried on a computer-readable storage medium, wherein the computer program, when executed by a computer, can implement the message display method as described in the embodiment shown in FIG. 2 above or the message processing method as described in the embodiment shown in FIG. 5. In such embodiments, the computer program can be downloaded and installed from a network, and/or installed from a removable medium. When the computer program is executed by a processor, various functions defined in the system of the present application are executed.

It should be noted that the embodiments of the present application may involve the use of user data. In practical applications, user-specific personal data can be used in the schemes described herein within the scope permitted by applicable laws and regulations (e.g., with explicit user consent, effective notification to the user, etc.), in compliance with the requirements of applicable laws and regulations in the country where it is used.

Those skilled in the art can clearly understand that, for the convenience and brevity of the description, the specific working processes of the systems, apparatuses, and units described above can refer to the corresponding processes in the foregoing method embodiments, and will not be repeated here.

The apparatus embodiments described above are merely illustrative, wherein the units described as separate components may or may not be physically separate, and the components displayed as units may or may not be physical units, that is, they may be located in one place, or may be distributed across a plurality of network units. Some or all of the modules can be selected according to actual needs to achieve the purpose of the embodiments. Those of ordinary skill in the art can understand and implement without creative labor.

Through the description of the above embodiments, those skilled in the art can clearly understand that each embodiment can be implemented by means of software plus a necessary general-purpose hardware platform, or, certainly, by means of hardware. Based on such understanding, the above technical solution, in essence or in the part that contributes to the prior art, can be embodied in the form of a software product. The computer software product can be stored in a computer-readable storage medium, such as ROM/RAM, magnetic disk, optical disk, etc., including several instructions to cause a computer device (which can be a personal computer, a server, or a network device, etc.) to perform the methods described in various embodiments or parts of the embodiments.

Finally, it should be noted that the above embodiments are only used to illustrate the technical solutions of the present application, and are not intended to limit them; although the present application has been described in detail with reference to the foregoing embodiments, those of ordinary skill in the art should understand that they can still modify the technical solutions described in the foregoing embodiments, or make equivalent substitutions for some of the technical features; and these modifications or substitutions do not cause the essence of the corresponding technical solutions to depart from the spirit and scope of the technical solutions of the embodiments of the present application.

What is claimed is:

1. A message display method, comprising:
displaying a message display interface for a first session object associated with a target session connection, wherein the target session connection corresponds to a plurality of session objects; and
based on at least two organizations to which the plurality of session objects belong, displaying, on the message display interface, session messages belonging to different organizations according to a first display style corresponding to each respective organization, wherein the first display styles corresponding to the different organizations are distinct.

2. The method according to claim 1, further comprising:
when a session message associated with a first organization, to which the first session object belongs, is displayed using the first display style corresponding to the first organization, displaying a first session message of the first session object and a second session message, different from the first session message but also associated with the first organization, according to distinct second display styles.

3. The method according to claim 1, further comprising:
for a session message associated with a first organization to which the first session object belongs, displaying session identification information generated based on a respective session object identifier corresponding to the session message; and
for a session message associated with an organization other than the first organization, displaying session identification information generated based on a respective organization identifier corresponding to the session message.

4. The method according to claim 1, further comprising:
determining a plurality of session messages within a same organization that satisfy an association condition;
determining an aggregated message generated based on the plurality of session messages; and
displaying the aggregated message according to the first display style corresponding to the organization.

5. The method according to claim 4, wherein:
determining the plurality of session messages within the same organization that satisfy the association condition comprises one of:
determining a plurality of session messages associated with a same topic and belonging to the same organization; or
determining a plurality of consecutively displayed session messages belonging to the same organization;
determining the aggregated message generated based on the plurality of session messages comprises one of:
determining message prompt information generated from the plurality of session messages;
determining a card message carrying message prompt information corresponding to the plurality of session messages; or
determining an aggregated message based on a first session message of the plurality of session messages and content of the plurality of session messages; and
displaying the aggregated message according to the first display style corresponding to the organization comprises one of:
displaying the aggregated message as a new message according to the first display style corresponding to the organization; or
updating the plurality of session messages to become the aggregated message.

6. The method according to claim 1, wherein the first display style comprises one or more selected from a group including: a message background color, a font type, a font color, a font size, a message marker, and a display area; and
wherein displaying, on the message display interface, session messages belonging to different organizations according to the first display style corresponding to each respective organization comprises one or more of:
setting session messages belonging to different organizations to different message background colors;
setting session messages belonging to different organizations to different font types;
setting session messages belonging to different organizations to different font colors;
setting session messages belonging to different organizations to different font sizes;
setting session messages belonging to different organizations to different message markers; or
displaying session messages belonging to different organizations in different display areas.

7. The method according to claim 1, wherein the displaying, on the message display interface, session messages belonging to different organizations according to a first display style corresponding to each respective organization comprises:
displaying, in a first display area of the message display interface, session messages associated with a first organization to which the first session object belongs; and
displaying, in a second display area of the message display interface, session messages associated with organizations other than the first organization, wherein the messages from other organizations are displayed according to a third display style corresponding to their respective organization, and wherein the third display styles for different organizations are distinct.

8. The method according to claim 1, wherein the at least two organizations comprise a logistics demanding party and a logistics service party; and
wherein displaying, on the message display interface, session messages belonging to different organizations according to a first display style corresponding to each respective organization comprises:
displaying session messages belonging to the logistics demanding party according to a first display style specific to the logistics demanding party; and
displaying session messages belonging to the logistics service party according to a first display style specific to the logistics service party, wherein the first display style specific to the logistics demanding party is different from the first display style specific to the logistics service party.

9. The method according to claim 8, wherein a session message comprises a card message generated based on a logistics plan, the method further comprising:
when the first session object belongs to the logistics demanding party and the card message is from the logistics service party, in response to an order placement operation triggered by the first session object on an order placement control within the card message, sending an order placement request to a server; and
when the first session object belongs to the logistics service party and the card message is from the logistics demanding party, in response to an update operation by the first session object concerning the logistics plan, updating the card message.

10. The method according to claim 8, wherein the first session object belongs to the logistics demanding party, the method further comprising:
receiving a session request sent by the first session object regarding a logistics plan provided by a logistics service party; and
sending the session request to a server, to enable the server to establish the target session connection, the target session connection comprising the plurality of session objects including the first session object, based on session objects corresponding respectively to the logistics demanding party and the logistics service party.

11. The method according to claim 10, further comprising:
providing a plan display interface;
displaying, on the plan display interface, plan prompt information and session prompt information for a plurality of logistics plans;
wherein receiving the session request sent by the first session object regarding the logistics plan provided by the logistics service party comprises:
in response to a trigger operation on any piece of the session prompt information, generating the session request for a corresponding logistics service party associated with the triggered session prompt information.

12. A message processing method, comprising:
determining a target session connection among a plurality of session objects;
determining at least two organizations to which the plurality of session objects belong;
determining a respective first display style for each of the at least two organizations, wherein the first display styles are distinct for different organizations; and
sending the respective first display style for each of the different organizations to a client device of a first session object among the plurality of session objects, to enable the client device to display, on a message display interface, session messages from the different organizations according to their respective first display styles.

13. The method according to claim 12, wherein the first display style comprises one or more selected from a group including: a message background color, a font type, a font color, a font size, a message marker, and a display area.

14. An electronic device comprising:
one or more processors; and
one or more computer-readable memories coupled to the one or more processors and having instructions stored thereon that are executable by the one or more processors to perform one or more operations comprising:
displaying a message display interface for a first session object associated with a target session connection, wherein the target session connection corresponds to a plurality of session objects; and
based on at least two organizations to which the plurality of session objects belong, displaying, on the message display interface, session messages belonging to different organizations according to a first display style corresponding to each respective organization, wherein the first display styles corresponding to the different organizations are distinct.

15. The electronic device according to claim 14, wherein the operations further comprises:
when a session message associated with a first organization, to which the first session object belongs, is displayed using the first display style corresponding to the first organization, displaying a first session message of the first session object and a second session message, different from the first session message but also associated with the first organization, according to distinct second display styles.

16. The electronic device according to claim 14, wherein the operations further comprises:
for a session message associated with a first organization to which the first session object belongs, displaying session identification information generated based on a respective session object identifier corresponding to the session message; and
for a session message associated with an organization other than the first organization, displaying session identification information generated based on a respective organization identifier corresponding to the session message.

17. The electronic device according to claim 14, wherein the operations further comprises:
determining a plurality of session messages within a same organization that satisfy an association condition;
determining an aggregated message generated based on the plurality of session messages; and
displaying the aggregated message according to the first display style corresponding to the organization.

18. The electronic device according to claim 17, wherein:
determining the plurality of session messages within the same organization that satisfy the association condition comprises one of:
determining a plurality of session messages associated with a same topic and belonging to the same organization; or
determining a plurality of consecutively displayed session messages belonging to the same organization;
determining the aggregated message generated based on the plurality of session messages comprises one of:
determining message prompt information generated from the plurality of session messages;
determining a card message carrying message prompt information corresponding to the plurality of session messages; or
determining an aggregated message based on a first session message of the plurality of session messages and content of the plurality of session messages; and
displaying the aggregated message according to the first display style corresponding to the organization comprises one of:
displaying the aggregated message as a new message according to the first display style corresponding to the organization; or
updating the plurality of session messages to become the aggregated message.

19. The electronic device according to claim 14, wherein the displaying, on the message display interface, session messages belonging to different organizations according to a first display style corresponding to each respective organization comprises:
displaying, in a first display area of the message display interface, session messages associated with a first organization to which the first session object belongs; and
displaying, in a second display area of the message display interface, session messages associated with organizations other than the first organization, wherein the messages from other organizations are displayed according to a third display style corresponding to their respective organization, and wherein the third display styles for different organizations are distinct.

20. The electronic device according to claim 14, wherein the at least two organizations comprise a logistics demanding party and a logistics service party; and
wherein displaying, on the message display interface, session messages belonging to different organizations according to a first display style corresponding to each respective organization comprises:
displaying session messages belonging to the logistics demanding party according to a first display style specific to the logistics demanding party; and
displaying session messages belonging to the logistics service party according to a first display style specific to the logistics service party, wherein the first display style specific to the logistics demanding party is different from the first display style specific to the logistics service party.
